(19) United States
(12) Patent Application Publication
(10) Pub. No.: US 2023/0399570 A1
(43) Pub. Date: Dec. 14, 2023

(54) CONVERSION OF CO2 TO CHEMICAL ENERGY CARRIERS AND PRODUCTS

(71) Applicant: Karlsruher Institut fuer Technologie, Karlsruhe (DE)

(72) Inventors: Tim BOELTKEN, Karlsruhe (DE); Roland DITTMEYER, Karlsruhe (DE); Peter PFEIFER, Linkenheim (DE)

(21) Appl. No.: 18/034,959

(22) PCT Filed: Oct. 11, 2021
(86) PCT No.: PCT/EP2021/077995

§ 371 Date: May 2, 2023

(30) Foreign Application Priority Data
Nov. 3, 2020 (DE) 10 2020 128 868.9

(51) Int. Cl. C10G 2/00; C25B 1/23; C25B 1/04; C10L 3/08; C25B 15/08; C10G 67/14

(52) U.S. Cl. CPC C10G 2/34; C25B 1/23; C25B 1/04; C10L 3/08; C25B 15/081; C10G 2/50; C10G 67/14; C10G 2300/4043; C10G 2300/42; C10L 2290/42

(57) ABSTRACT

The present invention relates to methods for the conversion of CO₂ to chemical energy carriers and products, in particular via a methanation of the gas phase fraction from a Fischer-Tropsch synthesis.

All documents cited in the present application are incorporated by reference in their entirety into the present disclosure (=incorporated by reference in their entirety).

The present invention relates to methods for converting CO₂ into chemical energy carriers and products, in particular via a methanation of the gas phase fraction from a Fischer-Tropsch synthesis.

The Fischer-Tropsch synthesis (FTS) method used to produce hydrocarbons has been known for many decades. In this process, a synthesis gas consisting mainly of carbon monoxide (CO) and hydrogen (H₂) is converted to hydrocarbons by heterogeneous catalysis in a synthesis reactor. In the outlet stream of Fischer-Tropsch synthesis units, in which synthesis gas is synthesized into hydrocarbons according to the Fischer-Tropsch process, four fractions can usually be distinguished:
A gas phase consisting of non-converted synthesis gas (mainly CO, H₂), short-chain hydrocarbons and volatile components of the by-products as well as CO₂.
A waxy phase of long-chain hydrocarbons that is solid at ambient temperature and pressure (wax phase or wax fraction).
A hydrophobic phase of shorter-chain hydrocarbons that is liquid at ambient temperature and pressure (oil phase).
An aqueous phase of forming reaction water and organic compounds dissolved therein.

Processes are known in which the wax and oil phases produced by the Fischer-Tropsch synthesis are processed by treatment with hydrogen by means of so-called hydrotreatment in refineries to standard-compliant fuel products such as gasoline, diesel or kerosene.

Also known are processes in which the gas phase resulting from a Fischer-Tropsch synthesis is processed by means of methanation.

DE 10 2013 102 969 A1 describes the process chain of the electrolysis with Fischer-Tropsch synthesis and methane production. This document is aimed in particular at a temporally fluctuating electricity supply. A parallel processing of synthesis gas by methanation and Fischer-Tropsch synthesis is proposed, in which the different hydrogen consumption of the two syntheses is utilized to compensate for fluctuations; residual gases are combusted or fed to a reformation. In addition, as further prior art documents the following can be mentioned: US 2015/0099813 A1; US 2013/0270153 A1; U.S. Pat. No. 9,290,383 B2; U.S. Pat. No. 7,351,750 B2. Concerning methanation per se, without connection to Fischer-Tropsch syntheses, an article by Farsi et al. “A consecutive methanation scheme for conversion of CO₂—A study on Ni₃Fe catalyst in a short-contact time micro packed bed reactor”, Chemical Engineering Journal 388 (2020), pp. 1-11 could be mentioned.

One problem of today's technology is that carbon dioxide is produced or available in large quantities but is not used satisfactorily.

Another problem of the current state of the art is that the methanation of a gas phase from a Fischer-Tropsch synthesis is not satisfactorily possible if the synthesis gases fed into the Fischer-Tropsch synthesis have a CO₂ content of more than 50 vol. % in relation to the amount of carbon oxides, that is a mixture of CO and CO₂, used. Even at 15 to 50 vol. %, the possible degrees of conversion of the carbon contained in the carbon oxides in the Fischer-Tropsch synthesis are limited.

In this respect, there is still considerable potential for improvement based on the previous state of the art.

Accordingly, it was the object of the present invention to provide methods and devices which no longer exhibit the problems of the prior art, or at least only to a greatly reduced extent, or which exhibit new advantageous effects.

A way should be found to obtain chemical energy carriers from synthesis gas containing medium to high levels of CO₂.

In particular, a way should also be found to enable a methanation of the gas phase originating from a Fischer-Tropsch synthesis if the synthesis gases fed into the Fischer-Tropsch synthesis have a high CO₂ content.

Further objects result from the following description.

These and other objects are solved in the context of the present invention by the subject matter of the independent claims.

Preferred embodiments result from the dependent claims as well as the following description.

In the context of the present invention, all indications of quantity are to be understood as indications of weight, unless otherwise indicated.

In the context of the present invention, the term “ambient temperature” means a temperature of 20° C. Temperature indications are in degrees Celsius (° C.) unless otherwise indicated.

Unless otherwise indicated, the reactions or method steps mentioned are carried out at overpressure, i.e., at more than 3 barO, preferably more than 5 barO, particularly preferably at at least 19 barO.

In the context of the present invention, the term “long-chain hydrocarbons” is understood to mean hydrocarbons with at least 25 carbon atoms (C₂₅), preferably up to one hundred carbon atoms, (C₁₀₀). The long-chain hydrocarbons with at least 25 carbon atoms may be linear or branched and may partially contain monounsaturated hydrocarbon compounds.

In the context of the present invention, the term “shorter chain hydrocarbons” is understood to mean hydrocarbons with 5 to 24 carbon atoms (C₅-C₂₄). The shorter chain hydrocarbons with 5 to 24 carbon atoms may be linear or branched and may partially contain monounsaturated hydrocarbon compounds.

In the context of the present invention, the term “short-chain hydrocarbons” is understood to mean hydrocarbons having 1 to 4 carbon atoms (C₁-C₄). The short-chain hydrocarbons with 4 carbon atoms may be linear or branched and may partially contain monounsaturated hydrocarbon compounds.

In the context of the present invention, the term “wax phase” or “wax fraction” is understood to mean that product fraction of the Fischer-Tropsch synthesis which is characterized by long-chain hydrocarbons.

In the context of the present invention, the term “oil phase” is understood to mean that product fraction of the Fischer-Tropsch synthesis which is characterized by shorter-chain hydrocarbons. This fraction is also referred to as the fuel fraction in the context of the present invention. The products of this product fraction are often also referred to as fuels in the context of the present invention.

In the context of the present invention, “Fischer-Tropsch” is occasionally abbreviated to “FT” for convenience.

In the context of the present invention, “Reverse Water Gas Shift Reaction”, also referred to as “Inverse Water Gas Shift Reaction”, is occasionally abbreviated to “RWGS” for convenience.

In the context of the present invention, the terms “plant”, “unit” and “device” are sometimes used interchangeably. Similarly, a “reactor” may be referred to as a device or unit.

In the context of the present invention, “chemical energy carriers and products” are understood to mean a synthetic gas capable of being fed into a natural gas network, in particular a mixture of at least 80 vol. % methane with a Wobbe index of 37 to 60 MJ/m³, preferably 50 to 55 MJ/m³ and a calorific value of 30 to 47 MJ/m³.

In the context of the present invention, “a synthetic gas capable of being fed into a natural gas network” is understood to mean a gas which, with regard to calorific value and Wobbe index, complies with the regulations for a feed-in into the natural gas network without restriction of the degree of admixture in accordance with DVG worksheet G260 or DIN EN 16726:2019-11.

Subject matter of the present invention is, in particular, a method for converting CO₂, in particular into chemical energy carriers and products, comprising the following method steps or consisting thereof:
a) providing a synthesis gas comprising H₂, CO and CO₂,
b) feeding the synthesis gas to a Fischer-Tropsch synthesis, and converting the synthesis gas to a Fischer-Tropsch synthesis product comprising at least the following fractions
   i) fuel fraction,
   ii) wax fraction,
   iii) gaseous by-product phase,
   iv) aqueous phase,
c1) optional hydrogenation of the Fischer-Tropsch synthesis product from step b) with addition of hydrogen,
c2) multi-stage separation of the Fischer-Tropsch synthesis product from step b) or of the product from step c1) and separation of fractions i), ii) and iv),
d) methanation of the gaseous by-products in fraction iii) with addition of H₂, in particular to a synthetic gas capable of being fed into a natural gas network,
e) optionally further processing of fractions i), ii), iv).

The origin of the synthesis gas is in principle not limited as long as the synthesis gas has a CO₂ content of at least 5 vol. %. For example, the synthesis gas can be obtained from gasification of biomass, from synthesis gas production from fossil feedstocks (natural gas, crude oil, coal), or from electricity-based processes (conversion of electrolytically produced H₂ as well as CO₂).

In preferred embodiments of the present invention, the synthesis gas is formed from H₂O and CO₂ by means of high temperature co-electrolysis. In embodiments, the ratio of H₂O to CO₂ (v/v) is about 2:1 and the electrolysis is carried out at 750-850° C., in particular using electric power from renewable sources.

It is essential for the present invention to start from a synthesis gas stream containing at least 5 vol. % CO₂.

In a preferred embodiment of the present invention, the synthesis gas is processed by means of a CO₂ activation by H₂ from an H₂O electrolysis via the reverse water gas shift reaction (RWGS) at 750° C.-850° C. at 5-30 barO (pressure above atmospheric pressure) according to formal formation equation CO₂+H₂+(2 H₂)=>CO+H₂O+(2 H₂) on a catalyst before being fed into the FT synthesis after water separation at 20-30 barO.

In both high-temperature co-electrolysis as well as RWGS, the conversion of CO₂ is not complete, which is why a residual CO₂ content of greater than 5 vol. % remains.

Accordingly, in preferred embodiments of the present invention, step a) comprises the steps of
a1) formation of a synthesis gas by means of a high-temperature co-electrolysis of H₂O and CO₂,
a2) processing of the synthesis gas obtained in a1) by means of a CO₂ activation by H₂ from a H₂O electrolysis via the reverse water gas shift reaction RWGS,
or consists of these.

In embodiments of the present invention, it is possible to subject the fractions i) and/or ii) obtained in step c2) to (further) hydrogenative cracking. Thereby, it is possible to further adapt the obtained products to desired results.

Furthermore, in embodiments of the present invention it is possible to branch off a part of each of the products from steps b), c1), c2) and feed them to another use and to leave only a part in the method.

It is possible within the scope of the present invention to further process one or all of fractions i), ii), iv).

In preferred embodiments of the present invention, water produced during methanation is condensed out and separated. Preferably, this is done together with the methanation. This can be done either in a single plant part or by adding a separator downstream of the methanation reactor.

In most cases, the product of the methanation obtained in the method of the present invention is directly a synthetic gas capable of being fed into a natural gas network. This is because the method of the present invention yields a product whose calorific value and Wobbe index satisfy the relevant regulations for such a feed-in. Should the product nevertheless not satisfy these regulations in individual cases, it is possible to simply process the product by adding combustible substances such as propane or butane or inert gases such as CO or CO₂, depending on whether the Wobbe index and/or calorific value are too high or too low.

Accordingly, in embodiments of the present invention, the methanation product is directly fed-in into a natural gas network as a synthetic gas capable of being fed into a natural gas network.

Also subject matter of the present invention is an installation for converting CO₂, in particular into chemical energy carriers and products, comprising the following installation parts or consisting of them
A) a device configured to provide synthesis gas containing CO₂,
B) a Fischer-Tropsch synthesis device,
C1) optionally a single- or multi-stage device for the hydrogenating treatment of the Fischer-Tropsch products,
C2) a multi-stage separation device, preferably of several individual separation devices arranged one after the other,
D) a methanation device,
E) optionally a device for feeding the methanation product into a natural gas network,
wherein the components are in operative connection with each other.

Preferably, the multi-stage separation device C2) comprises a device configured to discharge and transfer the gaseous product fraction into the methanation device D).

In embodiments of the present invention, the device A) is a high-temperature co-electrolysis device configured for a high-temperature co-electrolysis of H₂O and CO₂ or, in other embodiments, an installation as described in WO 2019 048236.

In preferred embodiments, the device B) is a microstructure reactor as described in WO 2017/013003, that is a microstructure reactor for carrying out an exothermic reaction between two or more reactants which are passed in the form of fluids over one or more catalyst(s), comprising at least one stack sequence of a) at least one layer comprising one or more catalyst(s) for carrying out at least one exothermic reaction, b) at least one layer divided into two or more cooling fields, c) at least one layer having distribution structures with lines for distributing the coolant, with connections for supplying coolant to the lines of the distribution structure and for connection to the cooling fields, connections for discharging the heated coolant from the cooling fields and lines and connections for discharging the heated coolant from the stack sequence.

The devices C2) are preferably separation devices as known from the prior art, in particular distillation devices.

In preferred embodiments, the device D) is
D1) a methanation reactor comprising a water separation device or
D2) a methanation reactor and a downstream water separation device.

In further embodiments, the device D) may be according to WO 2017/211864.

In various embodiments, the water separation device may be a (simple) device for condensation and phase separation. In other embodiments, it may be a distillation device.

The installations according to the invention are in particular suitable and configured for carrying out the method according to the invention.

Thus, in particular, the direct combination of Fischer-Tropsch synthesis with downstream methanation of the gaseous product contents or non-converted educts using a CO₂-containing synthesis gas as educt gas with a CO₂ content of at least 5 vol. % is a subject matter of the present invention.

An advantage of the present invention is that, unlike in the prior art, hydrocarbons with chain lengths smaller than C4, which are generally considered as undesirable by-products in Fischer-Tropsch synthesis, are put to useful use in the context of the present invention.

Process control in the prior art is generally such that the formation of these products is minimized, which requires, inter alia, a limitation of the degree of conversion per pass and a recycling of the unreacted educts. In larger installations, the gases can be used thermally or to generate electricity. In smaller installations, the effort involved is uneconomical. If there is no use for the heat or electricity generated by combusting the gaseous contents, the carbon yield, the overall efficiency and also the operating efficiency of the method are reduced. In contrast, it is an advantage of the present invention that the carbon yield, overall efficiency and operating efficiency are increased with the present invention.

An advantage of the present invention is that a product gas suitable for feed-in is obtained as the product. As a result, in particular even without recirculation a high carbon yield is obtained.

An advantage of the present invention is that a significant improvement in the operating efficiency of “power-to-molecules” applications or electricity-based chemical energy carriers, in this case electricity plus CO₂ to methane, could be achieved.

In embodiments of the method according to the invention, the residual gas of the FT synthesis can be utilized almost completely, i.e., to a proportion of more than 90%, preferably more than 95%, particularly preferably more than 98% and especially preferably more than 99%, or a recycling of non-converted synthesis gas can be avoided. In such preferred embodiments of the present invention, the ratio of x H₂:(y CO₂+z CO) in fraction iii) satisfies the equation x=4y+3z, whereby it is ensured that near ideal conditions for methanation occur.

Where, in the description of the plant according to the invention, parts or the whole of the plant are identified as “consisting of”, this is to be understood as referring to the essential components mentioned. Self-evident or inherent parts such as pipes, valves, screws, housings, measuring devices, storage tanks for educts/products etc. are not excluded by this. Preferably, however, other essential components, such as additional reactors or the like would be, which would change the process flow, are excluded.

The various embodiments of the present invention, e.g.—but not exclusively—those of the various dependent claims, may thereby be combined with each other in any desired manner, provided that such combinations do not contradict each other.

### DESCRIPTION OF THE FIGURES

The present invention is explained in more detail below with reference to the drawings. The drawings are not to be construed as limiting and are not to scale.

Furthermore, the drawings do not contain all the features that are present in conventional plants, but are reduced to the features that are essential for the present invention and its understanding.

FIG. 1 shows an example of a method as it corresponds to a variant of the present invention. Synthesis gas 1 comprising H₂, CO and CO₂ is introduced into a Fischer-Tropsch reactor D. Pressurised water 5 is also introduced into this Fischer-Tropsch reactor D and pressurised steam 6 is led off by indirect heat exchange from the reactor. This steam 6 can be used for energy recovery, in particular via heat exchangers or turbines, or also to supply heat for reactions (neither of which is shown in the figure). The resulting FT product (comprising four fractions) is then led via a first heat exchanger WT to a first separation device A, where the wax fraction ii) is separated as bottoms. The remaining fractions leave the unit A overhead and are led via a second heat exchanger WT to a second separation device B, where the fuel fraction (oil phase) i) and the aqueous phase iv) are separated as bottoms. The gaseous by-products iii) are discharged overhead. Hydrogen 2 is then optionally added to this phase iii) and the mixture is fed into a methanation reactor E via a third heat exchanger WT. Pressurized water 5 is also introduced into this methanation reactor E and by pressurized steam 6 is led off indirect heat exchange from the methanation reactor E. The product is discharged from the methanation reactor E and passed via a fourth heat exchanger WT to a third separation device C, where the water 3 produced during methanation is condensed out and discharged and the remaining product gas 4 is discharged as synthetic gas capable of being fed into a natural gas network. The latter can then be fed-in into a natural gas network (not shown in the figure).

FIG. 2 shows in principle the same structure and procedure as FIG. 1. The only difference being that the FT product coming from the FT reactor D is fed with addition of hydrogen 2 via a heat exchanger WT into a hydrocracking reactor F, where the FT product is subjected to hydrogenation cracking so that, compared to FIG. 1, a lower content of wax fraction ii) and a higher content of fuel fraction i) are obtained before the first separation takes place. Subsequently, the transfer to a first separation device A and the same procedure as in FIG. 1 take place. The gas fractions are similar in both cases.

### LIST OF REFERENCE SIGNS

1 synthesis gas
2 hydrogen
3 condensed water
4 product gas (as synthetic gas that can be fed into a natural gas network)
5 pressurised water
6 pressurised water vapour
i) fuel fraction
ii) wax fraction
iii) gaseous by-product phase
iv) aqueous phase
A first separation device
B second separation device
C third separation device
D FT reactor
E methanation reactor
F hydrocracking reactor
WT heat exchanger

### EXAMPLES

The invention will now be further explained with reference to the following non-limiting examples.

### Example 1

A gas stream of 100 kg/h originating from a high temperature co-electrolysis with a composition of about 30 vol. % carbon monoxide, 64 vol. % H₂ (H₂/CO=2.2) and 6 vol. % CO₂ was converted with a CO conversion of 70% in a microstructured FT synthesis reactor at 20 barO. As a value product, only 19.9 kg/h FT product (sum of oil and wax) were obtained and 30.5 kg/h water (by-product of the synthesis). This meant that about 50% of the entering mass flow was not usable and would have had to be recycled at great expense in terms of energy. The composition of the gas was as follows in vol. %:

| | |
|---|---|
| 16.57 | CO₂ |
| 25.33 | CO |
| 0.07 | H₂O |
| 50.10 | H₂ |
| 6.26 | CH₄ |
| 0.33 | C2 |
| 0.59 | C3 |
| 0.42 | C4 |
| 0.21 | C5 |
| 0.08 | C6 |
| 0.02 | C7 |
| 0.01 | C8 |

By downstream addition of a single methanation reactor, the outlet temperature of which was set to 350° C., an almost complete conversion of the off-gas from the hydrocracking stage could be achieved by additional addition of further merely about 5.3 kg/h hydrogen. The composition of the product gas after methanation in vol. % was:

| | |
|---|---|
| CO | 0.01 |
| CO₂ | 2.64 |
| H₂ | 6.35 |
| H₂O | 0.06 |
| CH₄ | 85.84 |
| C2 | 0.79 |
| C3 | 1.83 |
| C4 | 1.32 |
| C5 | 0.78 |
| C6 | 0.35 |
| C7 | 0.08 |
| C8 | 0.02 |

(C2 to C8 represent the sum of the hydrocarbons with the corresponding carbon number).

Despite the content of residual CO₂ and residual H₂, this composition could be fed directly as synthetic natural gas with 0.282 kg/h, since the Wobbe index in this composition was about 53 MJ/m³ or 15.3 kWh/m³. During methane formation, another 0.289 kg/h of water was formed, which was condensed out. The gas quality was very good.

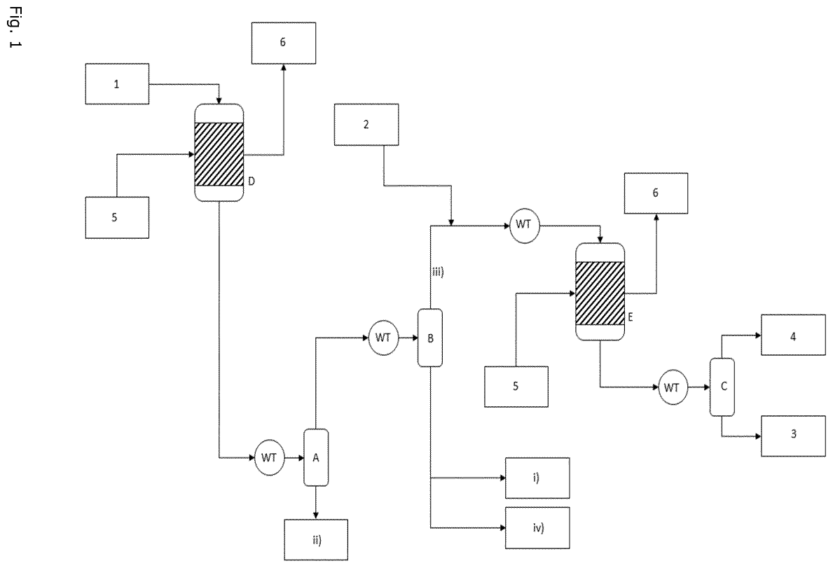

In an arrangement according to FIG. 1, method data were determined as follows:

| Stream | Type | Flow Rate [kg/h] |
|---|---|---|
| synthesis gas 1 | feed | 100 |
| hydrogen 2 | feed | 5.4 |
| fuel fraction ii) | product | 13.1 |
| product gas 4 | product | 25.8 |
| wax fraction ii) | product | 6.6 |
| aqueous phase iv) | by-product | 30.5 |
| water 3 | by-product | 29.4 |

The operating parameters were as follows:

| | Inlet | Inlet | Outlet |
|---|---|---|---|
| | Pressure | Temperature | Temperature |
| Installation Part | [barₐ] | [° C.] | [° C.] |
| FT reactor D | 21 | 220 | 235 |
| methanation reactor E | 20 | 275 | 350 |
| separation device A | 20 | 200 | 200 |
| separation device B | 20 | 10 | 10 |
| separation device C | 19 | 10 | 10 |

In this example, no treatment of the FT product was carried out (no hydrogenating cracking), but the FT product went directly into a multi-stage separation from which the four fractions were obtained. The product gas had a Wobbe index of 53 MJ/m³, as already mentioned.

### Example 2

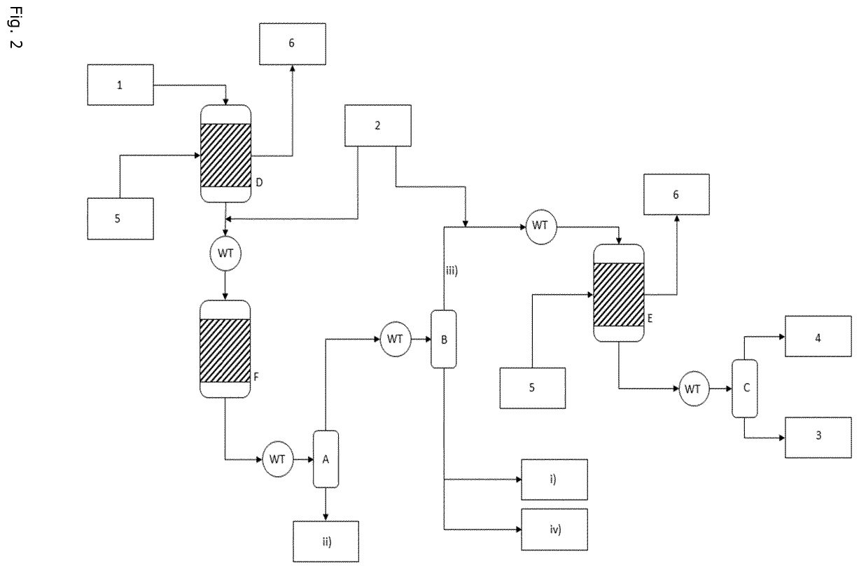

This example is largely identical to example 1, only slightly different compositions of the feed into the methanation result from the hydrocracking (that is reactor F in FIG. 2).

With identical educt gas composition, the FT product was post-treated by direct subsequent hydrocracking so that the wax fraction was finally less than 5 wt. % of the product yield (17.6 kg/h oil, 1.5 kg/h wax). An off-gas composition from the FT synthesis in vol. % was obtained as follows:

| | |
|---|---|
| 13.77 | CO₂ |
| 21.15 | CO |
| 0.07 | H₂O |
| 58.36 | H₂ |
| 5.23 | CH₄ |
| 0.27 | C2 |
| 0.56 | C3 |
| 0.34 | C4 |
| 0.17 | C5 |
| 0.06 | C6 |
| 0.02 | C7 |
| 0.00 | C8 |

In an arrangement according to FIG. 2, a conversion was carried out with the following characteristics:

| Stream | Type | Flow Rate [kg/h] |
|---|---|---|
| synthesis gas 1 | feed | 100 |
| hydrogen 2 | feed | 5.4 |
| fuel fraction ii) | product | 17.6 |
| product gas 4 | product | 26.3 |
| wax fraction ii) | product | 1.5 |
| aqueous phase iv) | by-product | 30.5 |
| water 3 | by-product | 29.4 |

The operating parameters were as follows:

| | Inlet | Inlet | Outlet |
|---|---|---|---|
| | Pressure | Temperature | Temperature |
| Installation Part | [barₐ] | [° C.] | [° C.] |
| FT reactor D | 21 | 220 | 235 |
| hydrocracking reactor F | 20 | 255 | 255 |
| methanation reactor E | 19 | 275 | 350 |
| separation device A | 20 | 200 | 200 |
| separation device B | 20 | 10 | 10 |
| separation device C | 19 | 10 | 10 |

In this example, the FT product first went into hydrogenating cracking and only then into a multi-stage separation, from which again the four fractions were obtained. The product gas also had a Wobbe index of 53 MJ/m³.

The product gas of the methanation had the following composition in vol. %:

| | |
|---|---|
| CO₂ | 1.80 |
| CO | 0.01 |
| H₂O | 0.06 |
| H₂ | 7.22 |
| CH₄ | 87.79 |
| C2 | 0.61 |
| C3 | 1.25 |
| C4 | 0.77 |
| C5 | 0.37 |
| C6 | 0.13 |

In Example 1, more waxes were obtained compared to Example 2.

In Example 2, on the other hand, the yield of fuels was maximized and only little wax was obtained compared to Example 1.

In both Examples 1 and 2, a product gas suitable for feed-in was obtained.

Thus, in both Examples a high carbon yield is obtained without recirculation.

1.-10. (canceled)

11. A method for converting CO₂ into chemical energy carriers and products, wherein the method comprises or consists of:
(a) provision of a synthesis gas comprising H₂, CO and CO₂, the synthesis gas having a CO₂ content of at least 5 vol. %,
(b) feeding the synthesis gas to a Fischer-Tropsch synthesis, and converting the synthesis gas to a Fischer-Tropsch synthesis product comprising at least the following fractions:
(i) a fuel fraction,
(ii) a wax fraction,
(iii) a gaseous by-product phase,
(iv) an aqueous phase,
(c1) optionally, hydrogenation of the Fischer-Tropsch synthesis product obtained in (b) with addition of hydrogen,
(c2) multi-stage separation of the Fischer-Tropsch synthesis product obtained in (b) or of the product obtained in (c1),
and separation of fractions (i), (ii) and (iv),
(d) methanation of the gaseous by-products in fraction (iii) with addition of H₂,
(e) optionally, further processing of fractions (i), (ii), (iv).

12. The method of claim 11, wherein (c1) is carried out.

13. The method of claim 11, wherein (e) is carried out.

14. The method of claim 11, wherein product obtained in (d) is fed directly into a natural gas network.

15. The method of claim 11, wherein the synthesis gas has been formed by a high-temperature co-electrolysis of H₂O and CO₂.

16. The method of claim 11, wherein the synthesis gas is processed by a CO₂ activation by H₂ from an H₂O electrolysis via a reverse water gas shift (RWGS) reaction.

17. The method of claim 11, wherein water produced during the methanation in (d) is condensed out and separated.

18. An installation for the conversion of CO₂, wherein the installation comprises or consists of the following components:
(A) a device configured for providing synthesis gas containing CO₂,
(B) a Fischer-Tropsch synthesis device,
(C1) optionally, a hydrogenation device,
(C2) a multi-stage separation device,
(D) a methanation device,
(E) optionally, a device for introducing methanation product into a natural gas network,
the components being in operative connection with one another.

19. The installation of claim 18, wherein (C1) is present.

20. The installation of claim 18, wherein (E) is present.

21. The installation of claim 18, wherein (C2) is present in the form of several individual separation devices arranged one after the other.

22. The installation of claim 18, wherein (C2) comprises a device configured for discharging and transferring a gaseous product fraction into device (D).

23. The installation of claim 18, wherein device (A) is a high temperature co-electrolysis device configured for high temperature co-electrolysis of H₂O and CO₂.

24. The installation of claim 18, wherein device (B) is a microstructure reactor for carrying out an exothermic reaction between two or more reactants, wherein reactants are passed in the form of fluids over one or more catalyst(s), comprising at least one stack sequence of (a) at least one layer comprising one or more catalyst(s) for carrying out at least one exothermic reaction, (b) at least one layer subdivided into two or more cooling fields, (c) at least one layer having distribution structures with lines for distributing coolant, with connections for supplying coolant to the lines of the distribution structure and for connection to the cooling fields, connections for discharging heated coolant from the cooling fields, and lines and connections for discharging heated coolant from the stack sequence.

25. The installation of claim 18, wherein devices (C1) and (C2) are separation devices.

26. The installation of claim 18, wherein devices (C1) and (C2) are distillation devices.

27. The installation of claim 18, wherein device (D) is
(D1) a methanation reactor comprising a water separation device.

28. The installation of claim 27, wherein the water separation device is a device for condensation and phase separation or a distillation device.

29. The installation of claim 18, wherein device (D) is
(D2) a methanation reactor and a downstream water separation device.

30. The installation of claim 29, wherein the water separation device is a device for condensation and phase separation or a distillation device.
